(19) United States
(12) Patent Application Publication
(10) Pub. No.: US 2010/0092001 A1
(43) Pub. Date: Apr. 15, 2010

(54) COUPLER FOR OPEN FITTING HEARING AID MEASUREMENTS

(75) Inventors: Oleg Saltykov, Fairlawn, NJ (US); Anton Gebert, Kleinsendelbach (DE); Ottmar Ruschig, Forchheim (DE); Marco Lederer, Hirschaid/Erlach (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignees: Siemens Audiologische Technik GmbH, Erlangen (DE); Siemens Hearing Instruments, Inc., Piscataway, NJ (US)

(21) Appl. No.: 12/329,692

(22) Filed: Dec. 8, 2008

Related U.S. Application Data
(60) Provisional application No. 61/105,496, filed on Oct. 15, 2008.

(51) Int. Cl. H04R 29/00

(52) U.S. Cl. 381/60

(57) ABSTRACT

In a system and method for open fitting hearing aid frequency response sound measurements, a test space is provided having located therein a sound source, a hearing aid with a microphone, and an open fit receiver. An acoustic shield is provided and within the acoustic shield an ear simulator coupler is provided having an ear extension attached thereto, the ear extension having mounted thereto at least a portion of the open fit receiver. A measurement unit receives sound signals from the ear simulator coupler.

### RELATED APPLICATION

This application claims the benefit of the filing date of a provisional application titled: COUPLER FOR OPEN FITTING filed Oct. 15, 2008 and identified in the U.S. Patent Office records as Ser. No. 61/105,496, said provisional application being incorporated herein by reference.

### BACKGROUND

Hearing aid measurements are performed by using a closed fitting (occluded fitting). Reference can be made to IEC 60118 series of standards or the ANSI S3.22 standard. Closed fitting means that the acoustic output of the hearing aid is sealed to the measurement coupler or ear simulator. The couplers used for hearing aid measurements are described for example in the IEC 60318 series of standards.

During the last couple of years, so called open fitted hearing aids have become very popular. Examples are: thin tube instruments with dome; or Receiver In the Canal Instruments with dome.

It is desirable to measure hearing aid performance in open fitting conditions, in which INSITU conditions are simulated as much as possible. Closed fit measurement provides a response which deviates very much from the INSITU conditions.

It has been proposed to measure in closed fitting conditions and then apply post-measurement correction curves.

The problems with non-occluded coupler measurements are for example:
a) summation of direct sound and processed sound results in an output frequency response with sharp notches (comb filter effect);
b) the sound leaking from the non-occluded coupler or ear simulator may lead to acoustic feedback which also distorts the output signal (frequency response); and
c) the summation in a) depends on the orientation and placement of the coupler and hearing aid relative to the sound source and processing delay of the circuit.

The problems have led to the conclusion that open fit measurements are not repeatable and thus not practical.

### SUMMARY

It is an object to provide a system and method for open fitting hearing aid measurements that are not repeatable.

In a system or method for open fitting hearing aid frequency response sound measurements, a test space is provided having located therein a sound source, a hearing aid with a microphone, and an open fit receiver. An acoustic shield is provided and within the acoustic shield an ear simulator coupler is provided having an ear extension attached thereto, the ear extension having mounted thereto at least a portion of the open fit receiver. A measurement unit receives sound signals from the ear simulator coupler.

### BRIEF DESCRIPTION OF THE DRAWINGS

FIG. 1 shows a test setup for Receiver-In-The-Canal (RIC) open fitting hearing aid measurements;

FIG. 2 illustrates in perspective view with cover removed an open fit coupler used in the RIC open fitting hearing aid measurement system;

FIG. 3 illustrates a cross-sectional view taken along line III-III of FIG. 2 showing details of the ear extension and of the RIC open fit receiver;

FIG. 4 shows a test setup for Behind-The-Ear (BTE) open fitting hearing aid measurements;

FIG. 5 shows a test setup for In-The-Ear (ITE) open fitting hearing aid measurements;

FIG. 6 shows a simulated response of an RIC open fitted hearing aid system of FIGS. 1-3 subjected to open fitting hearing aid measurements; and

FIG. 7 shows frequency responses of RIC open fit hearing aids obtained on an open fit coupler as shown in FIGS. 1-3.

### DESCRIPTION OF THE PREFERRED EMBODIMENTS

For the purposes of promoting an understanding of the principles of the invention, reference will now be made to the preferred embodiments/best mode illustrated in the drawings and specific language will be used to describe the same. It will nevertheless be understood that no limitation of the scope of the invention is thereby intended, and such alterations and further modifications in the illustrated devices and such further applications of the principles of the invention as illustrated as would normally occur to one skilled in the art to which the invention relates are included.

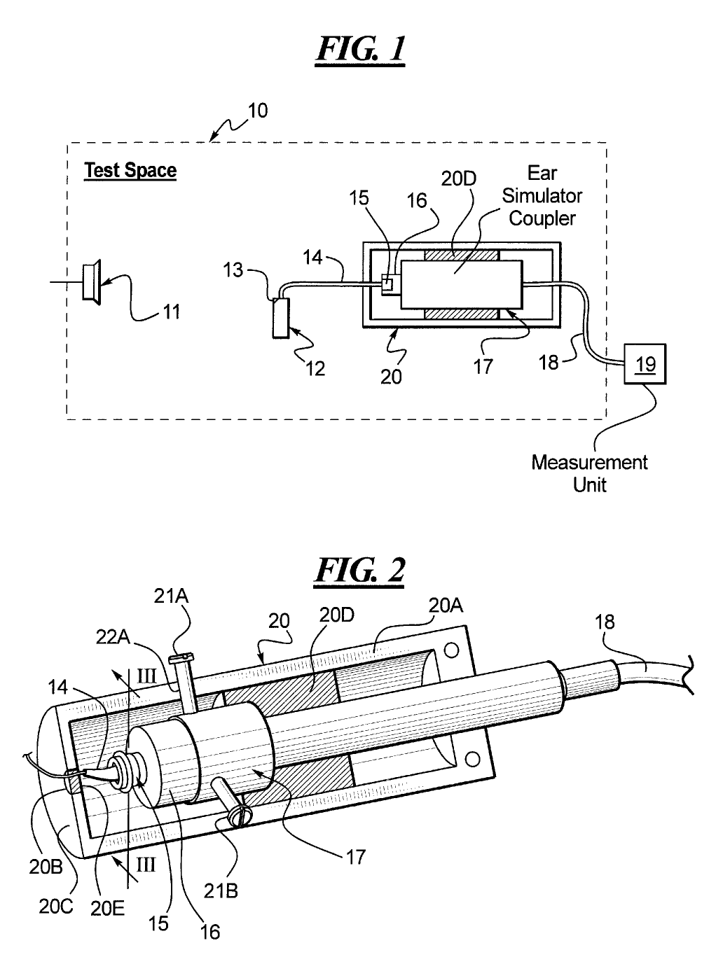

According to the preferred embodiment shown with the RIG (Receiver-In-The-Canal) test setup of FIG. 1, an acoustic shield around an RIC standard configuration as described in coupler standards (IECA and ANSI) is provided. This shield is designed in a way that: a) the sound can leak out from the ear coupler; and b) the acoustic volume of the acoustic shield is large enough.

The acoustic shield can be designed in different ways. One preferred way is shown in FIGS. 1 and 2. In these drawing figures the shield is designed as a closed cavity. Sound absorbing material 20 may optionally be provided inside the acoustic shield as shown to avoid resonances in the enclosure. Alternatively it can be designed as an open cavity (FIG. 5) with sound absorbing material.

As shown in FIG. 1, a test space 10 is provided having a sound source 11 therein. A hearing aid 12 having a hearing aid microphone 13 is connected by a cable 14 to a hearing aid Receiver-In-The-Canal (RIC) open fit receiver 15 formed of a receiver element 15B with a dome tip 15A (open fit) connected thereto. This RIC open fit receiver 15 is mounted in an ear extension 16 connected to an ear simulator coupler 17. The ear simulator coupler 17 connects via a cable 18 running from inside to outside the test space 10 to sound measurement unit 19. The ear simulator coupler is known in the prior art, such as the IEC 603184 (formerly the IEC 711) (4157 of Bruell and Kjaer)) or the HA1, HA2 (Frye Electrontics). Other ear simulator couplers that may be used are the Zwislocki; the IEC 60318-5 2 cm³ ear simulator couplers or other couplers.

An acoustic shield 20 surrounds the ear simulator coupler 17.

A more detailed perspective view of the ear simulator coupler 17 and acoustic shield 20 are shown in FIG. 2 but with a cover of the acoustic shield 20 removed. In FIG. 2, mounting screws 21A, B, for positioning the ear simulator coupler 17 inside the shield 20 are illustrated. One of these screws 21A is shown mounted in a threaded aperture 22A of a cylindrical sidewall 20A of the shield 20.

In FIG. 2, the ear simulator coupler 17 attached to cable 18 is shown in more detail along with the ear extension 16 and the open fit receiver 15. The cable 14 running to the hearing aid 12 is also shown passing through aperture 20B of end 20C of shield 20. A putty seal 20E around cable 14 closes off aperture 20B. The sound absorption material 20D can be placed inside the acoustic shield between the acoustic shield and the coupler to suppress acoustic resonances.

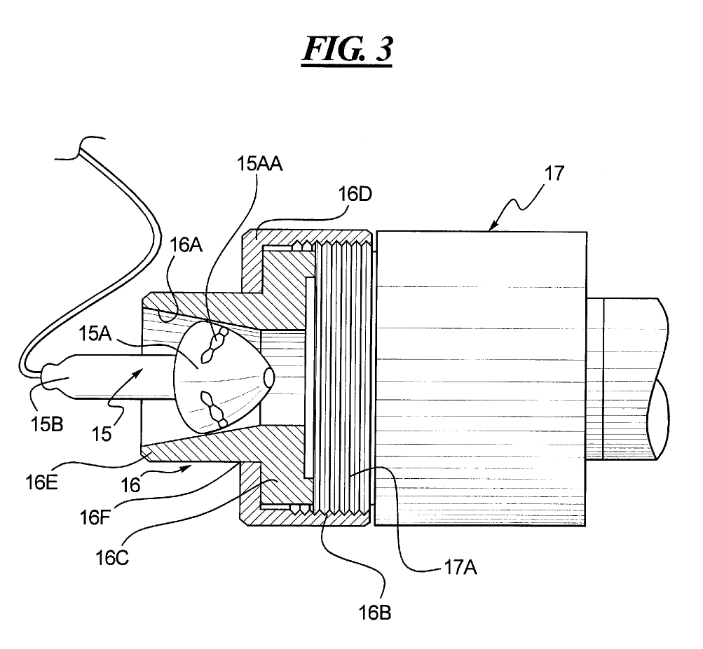

FIG. 3 shows a cross-sectional detail of the ear extension 16 and open fit receiver 15 mounted therein. The RIC open fit receiver 15 is formed of receiver element 15B and a dome (ear tip for open fit instruments) 15A with apertures 15A. As is known in the prior art, the outer periphery of the dome 15A contacts the ear canal inner walls. Because of the apertures 15M, it is an “open fit”. The previously known (see Bruel@Kjaer normal for 4157 ear simulator) ear extension 16 comprises an inner part 16C having a partial conical opening 16A receiving the dome 15A in a press fit relationship. The inner part 16C is retained to the ear simulator coupler 17 by screw threads 16B of a retaining cap 16D engaging with screw threads 17A on the end of the ear simulator coupler 17. The inner part 16C has a cylindrical protrusion 16E passing through an aperture 16F of the cap 16D.

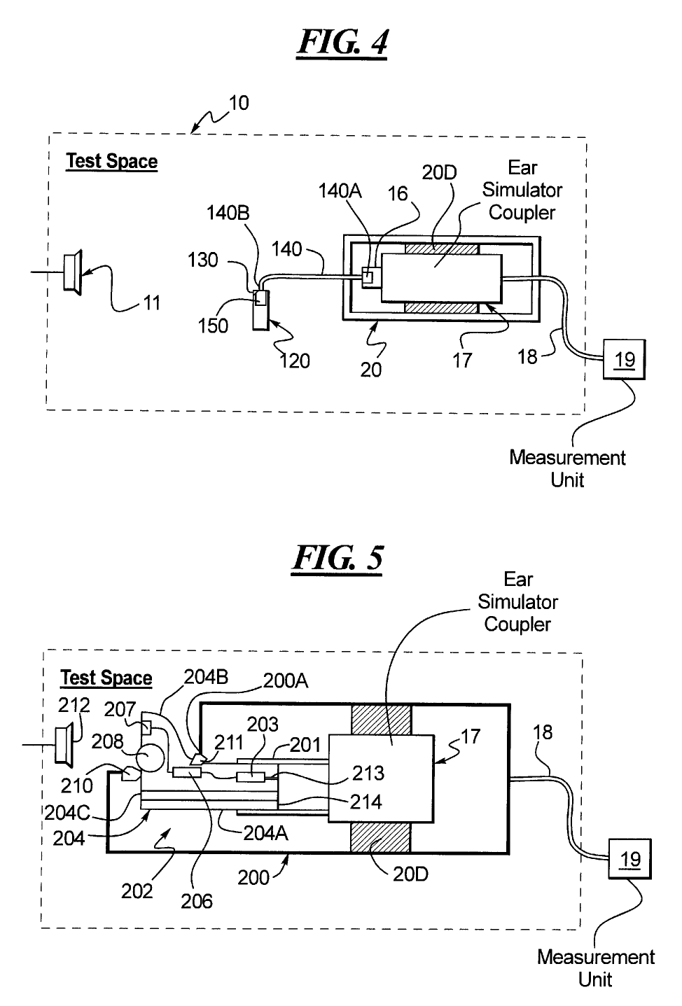

The RIC open fit receiver 15 shown with the dome 15A in FIGS. 1 and 3 is one possible way of realizing the open fit hearing aid. It is also possible that the receiver element is placed inside a Behind-The-Ear (BTE) hearing aid and is linked to the ear canal with a thin tube. The thin tube can also be terminated by a dome, similar to 15A. This will now be explained with reference to FIG. 4.

As shown in FIG. 4, a setup is shown for a Behind-The-Ear (BTE) hearing aid with a standard tubing or a thin tubing. Parts similar to FIG. 1 have retained the same reference numerals.

In FIG. 4, Behind-The-Ear (BTE) hearing aid 120 is provided having a microphone 130. A standard or thin tubing 140 for conveying sound waves extends at one end 140B from a receiver element 150 inside a main body of the hearing aid 120 into the simulated canal of the ear extension 16 where it terminates at an end portion 140A. The tubing end portion 140A may be connected to and suspended by a dome similar to 15A as shown in FIG. 3. The tubing 140 and tubing end portion 140A (which may also include the dome 15A) together with the receiver element 150 functions as, and thus forms, the BTE open fit receiver.

Alternatively, in FIG. 5, a setup for an In-The-Ear (ITE) hearing aid with venting is shown. Here an acoustic shield 200 surrounds the ear simulator coupler 17 located therein. A damping material 20D is provided between the acoustic shield 200 and the ear simulator coupler 17. The measurement unit 19 connects by cable 18 with the ear simulator coupler. At the input side, an ear extension 201 is provided, such as an open ended cylinder. This ear extension 201 receives at its open end an ITE hearing aid 202 with venting having an ITE open fit receiver element 203 located at a sound conveying channel 213 and supported in a cylindrical hearing aid body portion 204A of an overall hearing aid body 204. The cylindrical portion 204A merges into an enlarged portion 204B of the body 204. The body 204 also houses, in addition to the receiver element 203, a connected amplifier 206 connecting at its input side to a hearing aid microphone 207. A battery 208 is also provided in the enlarged portion 204B of the body 204.

Significantly a vent passage 204C passes through the body 204; thus the receiver element 203, the channel 213, and the vent passage 204C functioning together form the open fit receiver.

A putty seal 210 and another putty seal 211 close off an aperture 200A of the acoustic shield 200 where the enlarged portion 204B of the body 204 passes through so that the hearing aid microphone 207 is external to the acoustic shield 20. The sound source 212 sends sound waves for testing to the hearing aid microphone 207. The acoustic shield 200 with the ear simulator coupler 17 therein is provided within the test space 10 along with the hearing aid sound source 212.

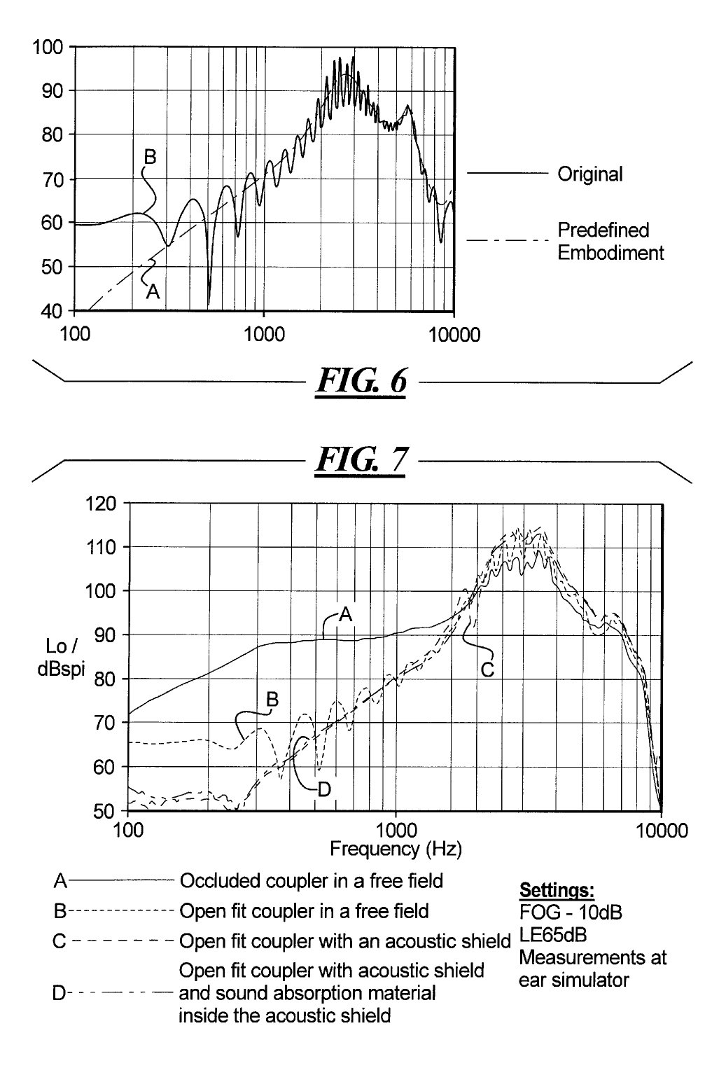

FIG. 6 shows a simulated response of the RIC open fit hearing aid instrument in conventional setup (original-solid line B) and in the preferred embodiment setup (preferred embodiment-dashed line A).

FIG. 7 shows the open fit coupler frequency response curves (RIC dome open-coupler installed) for: A—occluded coupler in a free field; B—open fit coupler in a free field; C—open fit coupler with an acoustic shield; and D—open fit coupler with acoustic shield and sound absorption material inside the acoustic shield.

Advantages of the preferred embodiments shown above are as follows:
a) no summation of direct and processed sound, since the direct sound cannot leak through the open fit ear mould (dome) into the coupler;
b) sound leaking from the open fit mould cannot reach the hearing aid microphone, thus eliminating feedback; and
c) alignment of the coupler relative to the hearing aid and sound source and the processing delay of the circuit are no longer critical.

While preferred embodiments have been illustrated and described in detail in the drawings and foregoing description, the same are to be considered as illustrative and not restrictive in character, it being understood that only the preferred embodiments have been shown and described and that all changes and modifications that come within the spirit of the invention both now or in the future are desired to be protected.

I claim as my invention:

1. A system for open fitting hearing aid frequency response sound measurements, comprising:
a test space having located therein a sound source, a hearing aid with a microphone and an open fit receiver;
an acoustic shield, and within the acoustic shield an ear simulator coupler having an ear extension attached thereto, said ear extension having mounted thereto at least a portion of said open fit receiver; and
a measurement unit receiving sound signals from said ear simulator coupler.

2. A system of claim 1 wherein said acoustic shield is cylindrical.

3. A system of claim 1 wherein said acoustic shield has threaded apertures for receiving mounting screws for positioning said ear simulator coupler therein.

4. A system of claim 1 wherein said acoustic shield has a removable cover.

5. A system of claim 1 wherein said ear simulator coupler has a cylindrical portion and has a smaller cylindrical body attached at one end as said ear extension.

6. A system of claim 1 wherein said measurement unit is connected by a cable passing through said acoustic shield from said ear simulator coupler.

7. A system of claim 1 wherein said sound source is at one side of said test space and is positioned to direct sound waves toward said microphone of said hearing aid which is positioned between said sound source and said acoustic shield housing said ear simulator coupler.

8. A system of claim 1 wherein a frequency response of signals output from said ear simulator coupler is a substantially smooth curve without undulations.

9. A system of claim 1 wherein said ear extension comprises a cylindrical projection having an internal conical opening, said open fit receiver comprising a dome with apertures, said dome being received in said conical opening in a press fit manner.

10. A system of claim 1 wherein a sound absorption material is provided inside the acoustic shield extending between the coupler and an inner wall of the shield.

11. A system of claim 1 wherein said open fit receiver comprises a receiver element mounted in said ear extension, a cable connecting said receiver element to a main body of said hearing aid having said microphone therein.

12. A system of claim 11 wherein said receiver element is tubular.

13. A system of claim 12 wherein said tubular receiver element connects with a dome press fit in an inner opening of said ear extension, said dome having at least one aperture therein.

14. A system of claim 1 wherein said open fit receiver comprises a receiver element in a body of said hearing aid also containing said microphone, a tubing having one end positioned at said receiver element and an opposite end as a tube portion received in said ear extension.

15. A system of claim 14 wherein said tube portion is mounted in said ear extension with a dome having at least one aperture.

16. A system of claim 1 wherein said open fit receiver comprises a receiver element mounted in a hearing aid body, a sound passage from said receiver element to an end face of said hearing aid body positioned in said ear extension, and a vent passage in said hearing aid body terminating at said end face in said ear extension.

17. A system of claim 16 wherein said ear extension is tubular in shape receiving a tubular portion of said hearing body.

18. A system of claim 16 wherein said acoustic shield has an opening through which an enlarged portion of said hearing aid body extends so that said microphone is installed in said enlarged portion of said hearing aid body exterior to said shield.

19. A system for open fitting hearing aid frequency response sound measurements, comprising:
a test space having located therein a sound source, a hearing aid with a microphone and an output connecting to an open fit receiver;
an acoustic shield, and within the acoustic shield an ear simulator coupler having an ear extension attached thereto, said ear extension having mounted thereto said open fit receiver which comprises a tubular receiver element attached to a dome having at least one aperture therein; and
a measurement unit receiving sound signals from said ear simulator coupler.

20. A system for open fitting hearing aid frequency response sound measurements, comprising:
a test space having located therein a sound source, a hearing aid with a microphone and an open fit receiver comprising a receiver element and a sound conveying tube having one end at said receiver element;
an acoustic shield, and within the acoustic shield an ear simulator coupler having an ear extension attached thereto, said ear extension having mounted thereto an opposite end of said tube together with an attached apertured dome; and
a measurement unit receiving sound signals from said ear simulator coupler.

21. A method for opening fitting hearing aid frequency response sound measurements, comprising the steps of:
providing a test space having located therein a sound source, a hearing aid with a microphone and an open fit receiver;
also providing an acoustic shield within said test space, and within the acoustic shield providing an ear simulator coupler having an ear extension attached thereto, said ear extension having mounted thereto at least a part of said open fit receiver;
providing a measurement unit receiving sound signals from said ear simulator coupler; and
performing frequency response sound measurements on the hearing aid with the open fit receiver by sending sounds from said sound source to said microphone of said hearing aid and making frequency response sound measurements for said hearing aid with open fit receiver by use of said measurement unit.

22. A method of claim 21 wherein said open fit receiver comprises a receiver element in said ear extension with an apertured dome.

23. A method of claim 21 wherein said open fit receiver comprises a receiver element with an associated sound tube, one end of said sound tube being located in said ear extension together with an apertured dome.

24. A method of claim 21 wherein said open fit receiver comprises a receiver element in a body of the hearing aid, said receiver element being positioned at one end of a sound channel in said hearing aid body, said hearing aid body having a vented passage, and an end of said vented passage and an end of said sound channel being located in said ear extension.

25. A method of claim 21 wherein a frequency response of signals output from said ear simulator coupler is a substantially smooth curve without undulations.
